(19) United States
(12) Patent Application Publication
(10) Pub. No.: US 2026/0370557 A1
(43) Pub. Date: Nov. 19, 2026

(54) METHODS AND APPARATUS FOR AI/ML REPRESENTATION MODEL MANAGEMENT IN A WIRELESS COMMUNICATION SYSTEM

(71) Applicant: SAMSUNG ELECTRONICS CO., LTD., Suwon-si, Gyeonggi-do (KR)

(72) Inventors: Chadi KHIRALLAH, Staines, Middlesex (GB); Mutasem HAMDAN, Staines, Middlesex (GB); Ezeddin Al HAKIM, Staines, Middlesex (GB)

(21) Appl. No.: 19/475,722

(22) PCT Filed: Apr. 15, 2024
(86) PCT No.: PCT/KR2024/005018

§ 371 Date: Oct. 15, 2025

(30) Foreign Application Priority Data
Apr. 17, 2023 (GB) 2305626.0
Mar. 4, 2024 (GB) 2403130.4

(51) Int. Cl. H04L 41/14; H04L 41/16

(52) U.S. Cl. CPC H04L 41/145; H04L 41/16

(57) ABSTRACT

The present disclosure relates to a 5G communication system or a 6G communication system for supporting higher data rates beyond a 4G communication system such as long term evolution (LTE). There is disclosed a method for managing a representation-model in a wireless communications network. The method comprises: transmitting, by a first network entity/function, to a second network entity/function, a first message relating to a representation-model management procedure; and in response to the first message, transmitting, by the second network entity/function, to the first network entity/function, a second message relating to the representation model management procedure.

### TECHNICAL FIELD

Certain examples of the present disclosure provide one or more techniques relating to Artificial Intelligence (AI)/Machine Learning (ML) representation model management in a communication network, for example a 3^{rd} Generation Partnership Project (3GPP) 6th Generation (6G) network.

### BACKGROUND ART

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyperconnectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

### DISCLOSURE OF INVENTION

### Technical Problem

The present disclosure relates to wireless communication systems and, more specifically, the present disclosure relates to AI/ML representation model managing in a wireless communication system.

### Solution to Problem

It is an aim of certain examples of the present disclosure to address, solve and/or mitigate, at least partly, at least one of the problems and/or disadvantages associated with the related art, for example at least one of the problems and/or disadvantages described herein. It is an aim of certain examples of the present disclosure to provide at least one advantage over the related art, for example at least one of the advantages described herein.

The present invention is defined in the independent claims. Advantageous features are defined in the dependent claims. Embodiments or examples disclosed in the description and/or FIGURES falling outside the scope of the claims are to be understood as examples useful for understanding the present invention.

Certain examples of the present disclosure provide a method for managing a representation-model in a wireless communications network, the method comprising: transmitting, by a first network entity/function, to a second network entity/function, a first message relating to a representation-model management procedure; and in response to the first message, transmitting, by the second network entity/function, to the first network entity/function, a second message relating to the representation-model management procedure.

In certain examples, the first message and/or the second message may comprise information relating to one or more representation-models relating to the procedure.

In certain examples, the information may comprise a representation-model profile.

In certain examples, the representation-model profile may comprise one or more parameters and/or Key Performance Indicators (KPIs) that one or more network entities/functions may assign, configure, allocate and/or recommend to be used during the representation-model management procedure.

In certain examples, the information may comprise one or more items of information according to the following table.

| Parameter Name | Semantics description/Examples |
|---|---|
| representation-model procedure ID | |
| representation-model ID | e.g. local ID or global ID, temporary ID, other |
| representation-model version number | e.g. v1.5 |
| representation-model domain | e.g. RU or CU or AI Application, other |
| representation-model domain data | e.g. hardware details, software details, geo-location, |
| | climate, weather, faults alarms, warnings, installation |
| | details, historical maintenance (active, or pro-active), |
| | etc. |
| representation-model detection criteria | e.g. newly added |
| representation-model similarity criteria | e.g. Information-theoretic, Large Margin Nearest |
| | Neighbour, Euclidian distance, Cosine |
| Similarity Measurement Matrix | Similarity matrix between each element in the network- |
| | domain |
| representation-model architecture | e.g. 3 dense layer of ANN |
| Representation-model Weights | e.g. e.g. w1 = 0.2, . . . w100 = 0 |
| Representation-model Size | e.g. 10 Mb |
| Representation-model Format | e.g. JSON, XML, h5 |
| Representation-model Type | e.g. auto-encoder, predictor, embedding |
| Representation-model Validation/Evaluation | e.g. 97% |
| Representation-model Validation/Evaluation Metric | e.g. Accuracy/Reward/Precision/Recall/F1 |
| Representation-model Validation/Evaluation Type | e.g. System Performance/Inference |
| Representation-model Deployment Side | |
| Representation-model Training Side | |
| Representation-model Inference Side | |
| Training Session/procedure ID(s) | |
| Selection Session/procedure ID(s) | |
| Registration Session/procedure ID(s) | |
| Configuration Session/procedure ID(s) | |
| Subscription Session/procedure ID(s) | |
| Update Session/procedure ID(s) | |
| Detection Session/procedure ID(s) | |
| Other LCM Session/procedure ID(s) | |
| Updated Time | e.g. date |
| Updated Location | e.g. Cell ID, location coordinates, . . . |
| Subscriber List | e.g. Cell ID, Entity ID, IP(s) . . . ) |
| other | |

In certain examples, the first message may comprise a representation-model registration request message and the second message may comprise a representation-model registration response message.

In certain examples, at least one of the first and second network entities/functions may comprise a Representation-Model Management Controller (RMC) (e.g. an entity/function dedicated to representation-model management in the network).

In certain examples, at least a part of the first and/or second network entity/function (e.g. RMC) may be included in/co-located with one or more of: RAN; CN; AF; UE; a dedicated entity internal or external to the network; a server; a database; edge; and a cloud.

In certain examples, the representation-model management procedure may relate to one or more of: Network-Domain Monitoring; Representation-Model Handling; Representation-Model Registration; Representation-Model Selection; Representation-Model

Aggregation; Representation-Model Configuration; Representation-Model Training; Representation-Model Updating; Representation-Model Monitoring; Representation-Model Detection; Representation-Model Reporting; and Representation-Model Subscription.

In certain examples, Network-Domain Monitoring may comprise monitoring and/or detecting changes in the network in relation to one or more network-domains (e.g. changes related to one or more existing network-domains and/or one or more newly added network-domains).

In certain examples, monitoring and/or detecting changes may comprise: requesting (e.g. directly or indirectly) (e.g. by RMC) a status of one or more network-domains from one or more network entities/functions; and receiving (e.g. by RMC), from the network entities/functions, a current status of the one or more network-domains.

In certain examples, monitoring and/or detecting changes may comprise: subscribing (e.g. to RMC) to obtain any reporting of any changes or updates in one or more representation-models and/or one or more network-domains.

In certain examples, monitoring and/or detecting changes may comprise: reporting/indicating (e.g. to RMC or at least one other network entity/function) information relating to a change in one or more network-domains periodically and/or based on a pre-configured event rule, policy, condition, and/or threshold (e.g. configured by the network).

In certain examples, the method may further comprise, in response to detecting a change, performing (e.g. by RMC) one or more of: upon detection of a new network-domain, triggering a representation-model registration procedure, configuration and/or training; upon detection of a change/update of an existing network-domain, triggering representation-model configuration, training and/or representation-model profile update; upon detection of one or more newly added network-domains, requesting the newly added network-domains to register related information with one or more network entities/functions.

In certain examples, the method may further comprise: concatenating/combining (e.g. by RMC) two or more representation-models from different network-domains to obtain a representation-model representing the concatenated/combined network-domains.

In certain examples, the representation-model management procedure may include an action relating to one or more of: a request; a response; an acknowledge; a notification; a report; and a failure, relating to the representation-model management procedure.

In certain examples, the method may further comprise: in response to detecting a change in one or more network-domains (e.g. addition, removal, modification and/or reconfiguration of one or more network-domains), retrieving information related to one or more network-domains that are involved in the change.

In certain examples, the method may further comprise: in response to detecting a change in one or more network-domains (e.g. addition, removal, modification and/or reconfiguration of one or more network-domains), creating, by the first or second entity/function (e.g. RMC) a representation-model related to one or more network-domains that are involved in the change.

In certain examples, the representation-model may comprise a mapping of network-domain data to a set of one or more numerical values (e.g. a vector), the network-domain may comprise one or more of: a network entity/function; UE; server; AI application; and/or application function, and the network-domain data may comprise information relating to one or more of: one or more network-domains, a relation between two or more network-domains, and historical data.

In certain examples, the representation-model management procedure may be used for one or more of: fault detection (e.g. hardware fault detection); fault prediction (e.g. for a network element newly added to the network); fault alarm; conflict detection (e.g. conflict between SON functions and/or AI applications); conflict prediction (e.g. conflict between SON functions and/or AI applications); conflict alarm; and correlation of alarms and events.

In certain examples, the network may comprise one or more of the following types of network: 4G; 4G-Advanced; 5G; 5G-Advanced; 6G; NTN (e.g. NR-NTN and/or IoT-NTN); and TN; Non-3GPP.

Certain examples of the present disclosure provide a first or second network entity/function (e.g. RMC) configured to perform a method according to any example, aspect, embodiment and/or claim disclosed herein.

Certain examples of the present disclosure provide a network (or wireless communication system) comprising a first network entity/function and a second network entity/function (e.g. at least one RMC) according to any example, aspect, embodiment and/or claim disclosed herein.

Certain examples of the present disclosure provide a computer program comprising instructions which, when the program is executed by a computer or processor, cause the computer or processor to carry out a method according to any example, aspect, embodiment and/or claim disclosed herein.

Certain examples of the present disclosure provide a computer or processor-readable data carrier having stored thereon a computer program according to any example, aspect, embodiment and/or claim disclosed herein.

Other aspects, advantages and salient features of the invention will become apparent to those skilled in the art from the following detailed description taken in conjunction with the accompanying drawings.

### Advantageous Effects of Invention

According to an embodiment of the disclosure, a wireless communication can be performed efficiently. Especially, AI/ML representation model management in a wireless communication system can be performed efficiently.

### BRIEF DESCRIPTION OF DRAWINGS

FIG. 1 illustrates an example of representation space of words;

FIG. 2 illustrates an example of a representation-model management procedure involving two Network (NW) Entities X, Y (or NW Functions X, Y, or NW Entity X and NW Function Y) in two Actions A and B;

FIG. 3 illustrates an example of a representation-model registration procedure involving a Client and Representation-Model Management Controller (RMC), in REPRESENTATION MODEL REGISTRATION REQUEST and REPRESENTATION-MODEL REGISTRATION REQUEST RESPONSE actions (or messages);

FIG. 4 illustrates a Representation Model AE_{RU};

FIG. 5 illustrates a Representation-vectors Matrix;

FIG. 6 illustrates a Similarity Matrix using Euclidian distance between the network elements;

FIG. 7 illustrates a Representation Model AE_{SON};

FIG. 8 illustrates a SONs Representation-vectors Matrix;

FIG. 9 illustrates a Similarity Matrix using Euclidian distance between the network elements;

FIG. 10 illustrates a mesh relationship between SON functions and network Radio-Frequency (RF) parameters (or network elements) and SON Code information;

FIG. 11 illustrates a Representation Model AE_{SON};

FIG. 12 illustrates a SONs Representation-vectors Matrix;

FIG. 13 illustrates a Similarity Matrix using Euclidian distance between the network elements; and

FIG. 14 is a block diagram of an exemplary network entity that may be used in certain examples of the present disclosure.

### MODE FOR THE INVENTION

Herein, the following documents are referenced and the contents thereof are incorporated into the present disclosure:
[1] Bank, Dor, Noam Koenigstein, and Raja Giryes. “Autoencoders.” arXiv preprint arXiv:2003.05991 (2020).
[2] 3GPP Technical Specification (TS) 32.111-1 Technical Specification Group Services and System Aspects; Telecommunication management; Fault Management; Part 1: 3G fault management requirements, vol. v17, March 2022.
[3] 3GPP TS 32.111-2: “Telecommunication management; Fault Management; Part 2: Alarm Integration Reference Point (IRP) Information Service (IS)”.)
[4] 3GPP TS 28.516: “Fault Management (FM) for mobile networks that include virtualized network functions; Procedure”.
[5] 3rd Generation Partnership Project; Technical Specification Group Services and System Aspects; Management and orchestration; Network policy management for mobile networks based on Network Function Virtualization (NFV) scenarios (Release 16).
[6] Sana, Mohamed, and Emilio Calvanese Strinati. “Learning semantics: An opportunity for effective 6G communications.” 2022 IEEE 19th Annual Consumer Communications & Networking Conference (CCNC). IEEE, 2022.

Various acronyms, abbreviations and definitions used in the present disclosure are defined at the end of this description.

### Overview of Representation Models

Most of the AI/ML algorithms are mathematical models, which require all input and output of the models to be numeric. Transforming any object (e.g. real-word or digital) with non-numerical features into numerical values is a common problem in the AI/ML field. This transformation has been referred to using different terms, such as encoding, embedding, compressing and representing, however, the present disclosure uses the term “representing/representation”.

For example, Item Categories (e.g. Book, Food, Table), Colour (e.g. Red, Blue, Green), and Group (e.g. A, B, C) are non-numerical features that missing the relational information between the features. In some cases, the AI/ML algorithms need to calculate the distance or the similarity between features (e.g. Book and Food), which is not possible with non-numeric features.

There are multiple techniques to create representation models that map a set of features (numerical and non-numerical) to numerical features (a.k.a. representation vector). A good representation-model can capture the semantics of the input by placing semantically similar inputs close together in the representation space. For example, words such as “Book”, and “Paper” will be encoded close together (e.g. “Book”=1, “Paper”=2), and a word with different semantic (e.g. “Food”=450″) will be encoded far from the two words.

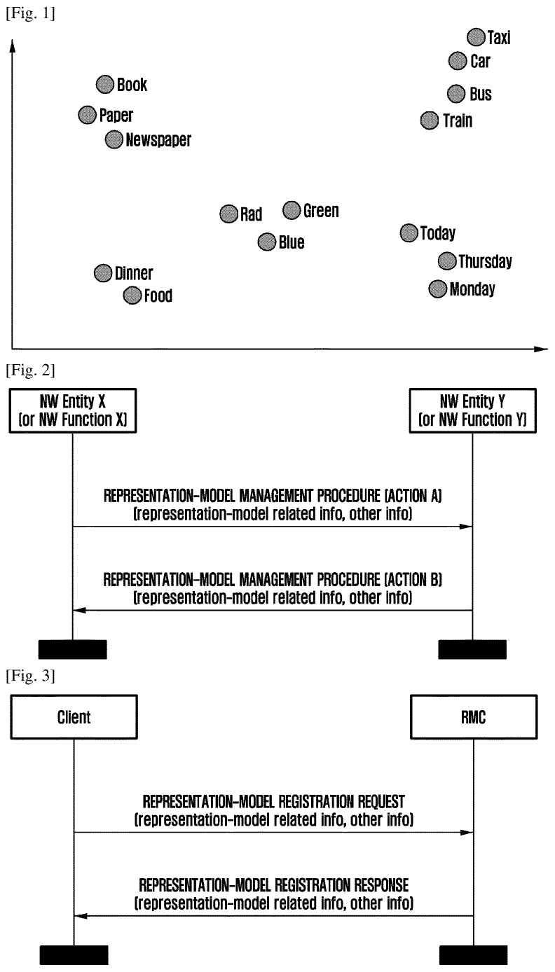

The representation models can be categorised into trainable models (e.g. Word Embedding, Neural Network Predictor and Neural Network Auto-Encoder) and nontrainable models [1]. A notably successful representations-model in Natural Language Processing is Word Embedding (e.g. Word2Vec), which captures the context of a word in a document and converts them to a representation space (see FIG. 1).

### Overview of Fault Management

Fault management is an important part of the operations and maintenance (OAM) of mobile networks. It is the process of monitoring, detecting, diagnosis, resolution, and correcting network fault occurrences in a mobile network. Examples of faults include hardware failure (e.g. network Entities), and software failure (e.g. network Function or AI Applications). Here are some examples of actions and services performed by fault management systems to keep the network operational [2]:
1. Fault detection: The system using an autonomous self-check circuits/procedures to discover the network entities with issues related to their operation or performance.
2. Fault Alarms: For each detected fault, appropriate alarms shall be generated by the faulty detection network entity. So the administrator of the network can see the alarm system as an embedding (or representation) that can notify/report faults using encapsulated information of the network entities alarms states [3].
3. Correlation of Alarms and Events: A single network fault may result in generating multiple alarms and events over time and spread geographically to other areas. So, if possible, the OAM should identify the information required for the implementation of its operations and notification emission for correlated Alarms/Faults and if possible alarm dataflow and alarm mapping of even a Virtual Network Function (VNF) instance/application visualization [4].

### Overview of AI Conflicts in the Mobile Networks and Open-RAN (O-RAN)

In mobile networks, conflict(s) may occur between different network entities or network functions, or even in the same network entity (or network function) due to the adversary in competing for network resources while trying to achieve certain goals. The 3GPP in the Self-Organizing Networks (SON) for 5th Generation (5G) networks shows that conflicts in parameter within the Centralized SON (e.g., Physical Cell ID (PCI) conflict) [3], or even between different policies as in [5].

The AI conflict in mobile networks can be defined as the state of disagreement or dispute on applying: policies, following rules, configuring, re-configuring parameters of one or more of the network elements between two or more of AI algorithms. As a result of the AI conflict, one or more of the network key performance indictors suffer from low, medium or high degradation.

The AI conflict in Open-RAN architecture supports conflict mitigation function to resolve potentially overlapping or conflicting requests from multiple xApps in the Near-Real-Time Radio Access Network (RAN) Intelligent Controller [3].

The above information is presented as background information only to assist with an understanding of the present disclosure. No determination has been made, and no assertion is made, as to whether any of the above might be applicable as prior art with regard to the present invention.

The following description of examples of the present disclosure, with reference to the accompanying drawings, is provided to assist in a comprehensive understanding of the present invention, as defined by the claims. The description includes various specific details to assist in that understanding but these are to be regarded as merely exemplary. Accordingly, those of ordinary skill in the art will recognize that various changes and modifications of the examples described herein can be made without departing from the scope of the invention.

The same or similar components may be designated by the same or similar reference numerals, although they may be illustrated in different drawings.

Detailed descriptions of techniques, structures, functions, operations or processes known in the art may be omitted for clarity and conciseness, and to avoid obscuring the subject matter of the present invention.

The terms and words used herein are not limited to the bibliographical or standard meanings, but, are merely used to enable a clear and consistent understanding of the invention.

Throughout the description and claims of this specification, the words “comprise”, “include” and “contain” and variations of the words, for example “comprising” and “comprises”, means “including but not limited to”, and is not intended to (and does not) exclude other features, elements, components, integers, steps, processes, operations, functions, characteristics, properties and/or groups thereof.

Throughout the description and claims of this specification, the singular form, for example “a”, “an” and “the”, encompasses the plural unless the context otherwise requires. For example, reference to “an object” includes reference to one or more of such objects.

Throughout the description and claims of this specification, language in the general form of “X for Y” (where Y is some action, process, operation, function, activity or step and X is some means for carrying out that action, process, operation, function, activity or step) encompasses means X adapted, configured or arranged specifically, but not necessarily exclusively, to do Y.

Features, elements, components, integers, steps, processes, operations, functions, characteristics, properties and/or groups thereof described or disclosed in conjunction with a particular aspect, embodiment, example or claim are to be understood to be applicable to any other aspect, embodiment, example or claim described herein unless incompatible therewith.

The skilled person will appreciate that the techniques described herein may be used in any suitable combination.

Certain examples of the present disclosure provide one or more techniques relating to AI/ML representation model management in a communication network, for example a 3GPP 6G network. However, the skilled person will appreciate that the present invention is not limited to these examples, and may be applied in any suitable system or standard, for example one or more existing and/or future generation wireless communication systems or standards, including any existing or future releases of the same standards specification, for example 3GPP 4G, 5G and/or 6G.

The functionality of the various network entities and other features disclosed herein may be applied to corresponding or equivalent entities or features in the same or any other suitable communication systems or standards. Corresponding or equivalent entities or features may be regarded as entities or features that perform the same or similar role, function or purpose within the network.

A particular network entity may be implemented as a network element on a dedicated hardware, as a software instance running on a dedicated hardware, and/or as a virtualised function instantiated on an appropriate platform, e.g. on a cloud infrastructure.

The skilled person will appreciate that the present invention is not limited to the specific examples disclosed herein. For example:
The techniques disclosed herein are not limited to 3GPP 6G.
One or more entities in the examples disclosed herein may be replaced with one or more alternative entities performing equivalent or corresponding functions, processes or operations.
One or more of the messages in the examples disclosed herein may be replaced with one or more alternative messages, signals or other type of information carriers that communicate equivalent or corresponding information.
One or more further elements or entities may be added to the examples disclosed herein.
One or more non-essential elements or entities may be omitted in certain examples.
The functions, processes or operations of a particular entity in one example may be divided between two or more separate entities in an alternative example.
The functions, processes or operations of two or more separate entities in one example may be performed by a single entity in an alternative example.
Information carried by a particular message in one example may be carried by two or more separate messages in an alternative example.
Information carried by two or more separate messages in one example may be carried by a single message in an alternative example.
The order in which operations are performed and/or the order in which messages are transmitted may be modified, if possible, in alternative examples.

Certain examples of the present disclosure may be provided in the form of an apparatus/device/network entity configured to perform one or more defined network functions and/or a method therefor. Certain examples of the present disclosure may be provided in the form of a system (e.g. network or wireless communication system) comprising one or more such apparatuses/devices/network entities, and/or a method therefor.

In the techniques of the related art, for example those referred to above, there occur the following problems.

The modern mobile network has become a complex system that is hard to maintain and optimize. Integrating artificial intelligence (AI) techniques into network is one way the industry is addressing these complexities. In the next generation of mobile networks (e.g. 5G-advanced, 6G), the AI system needs to be involved in many aspects of the mobile network, that is why it is important to have a representation-model for each entity and element in the mobile network to help the AI applications to extract meaningful and semantic features that are key enablers for 6G mobile networks [6].

A large number of future network entities and functions generates proportional representation-models. As a result, this imposes a challenging task to manage a large number of the representation-models in such future mobile networks. The management automation of all AI representation-models can enable solving in a generalized way many use-cases using the same framework, such as:
Fault Prediction (e.g., to predict what entities have a higher risk to develop faults in the future):
The current fault management system takes mainly into consideration the reported Alarms/Faults and does not consider future Alarms/Faults predictions. In addition, the OAM system for Fault Management has many limitations for gathering information, for example, the Hardware alarm list is limited by the manufacturer, similarly, the software/AI application bug reporting and error handling is limited by the developers' code structure. However, the representation-models can enable larger data to be added to the alarms' data such as Geolocation, weather, and installation details, and then transformed into representation vectors.
The similarities between these vectors can be numerically calculated using mathematical functions (e.g. Euclidean distance, Cosine and Dot Products). The calculated similarities can be used to predict fault development and/or risk of failure for close/nearest NW entities/functions/AI applications in the representation space that can worsen the mobile network performance.
Conflict detection (e.g., detect which SONs and/or AI application are adversely changing network parameters that degrade the mobile network performance):
Similar to the Fault Management, the SON in 3GPP and/or Conflict Mitigation in O-RAN use the data from different network entities/Functions to detect conflicts between different SON/AI Applications (e.g., xApps, Network Functions (NFs)).
However, the representation-models can extract the most related representation vector of the conflicts. Such representation vectors similarity measurements (e.g., Euclidean distance, Cosine and Dot Products between the representation spaces of the conflicts) indicates how much the conflicts are related or close to each other for AI/ML conflicts under monitoring. In addition such measurements can detect other AI/ML conflicts (hidden or newly developed) that the SON coordination or Conflict Mitigation does not include. Moreover, the dynamicity patterns of such similarity measurement can be used to predict future AI/ML conflicts.

Certain examples of the present disclosure provide one or more solutions to address the above problems. For example, certain examples of the present disclosure provide one or more techniques for addressing the following questions, (which are merely examples):
How to manage multiple representation-models that belong to/related to a large number of network (NW) entities, NW functions and/or AI/ML Applications
How to perform procedures such as measuring/quantifying representation vectors for the NW entities, NW functions and AI/ML Applications for given representation-model(s)
How to monitor and/or predict fault events related to a given NW entity (or a set of entities), NW function (or a set of functions), and/or AI/ML Application(s) based on given representation-model(s)
How to monitor and/or predict conflict events related to a given NW entity (or a set of entities), NW function (or a set of functions), and/or AI/ML Application(s) based on given representation-model(s)

Certain examples of the present disclosure provide one or more of the following techniques:
A method for representing at least one network-domain.
A “network-domain” may refer to at least one network entity (or function), User Equipment (UE) (or a group of UEs), server, AI Applications(s), Application Functions (AF), and/or any related information, configurations, parameters, etc.
Network-domain data may refer to network-domain information, relation between network-domains and/or historical data, etc.
The representation is defined as mapping of network-domain data to a vector and/or number(s). This mapping is termed for example, representation-model, or any other suitable naming. The representation-model can be defined as a AI/ML model and/or non-AI/ML model.
For example, representation (or mapping) of Radio Unit (RU) elements (e.g. with following data features: connected antenna(s), location, traffic load, consuming power, transmission power etc.) to a numerical vector.
The representation of a network-domain may include actions such as: calculation, estimation and/or prediction, etc. between network-domains.
For example, on representation use cases, but not limited to those use cases:
Fault prediction and AI/ML conflict prediction.
The representation numerical vector of a given network-domain contain information that describe or quantify the similarities (or closeness or relation, etc.) between the elements of the network-domain. The process of quantifying similarities may be based on configurations, rules, policies, and/or other methods.
The representation of a network-domain can be used as input to any AI/ML model and/or any other network entity (or function).
“AI/ML representation-model” or “representation-model” or “representation model” are used interchangeably in the present disclosure.
A new framework including new network entity (or a set of entities) and/or network function (or a set of functions) for management of representation-model(s) procedures in mobile communication networks.
The new (or existing) network entity and/or function can handle/manage a given representation-model related to at least one network-domain.
In one example, the new network entity and/or function may be included in (or part of, or co-located with) RAN, Core Network (CN), dedicated internal/external entity (or function), a server, database, cloud, Application Function (AF), and/or a UE (or a set of UEs), etc.
The new network entity (or entities) and/or network function (or functions) is (are) involved in at least one representation-model management procedure and/or action with a network entity (and/or network function) termed representation-model management controller (RMC).
In a related example, the RMC is a logical entity (or a function) that is located (or co-located) in (with) at least one new (or existing) network entity and/or function, and/or UE (or a group of UEs) and/or database, edge, cloud, server, application function, and/or any other internal or external network entity/function), and server, etc.
The new network entity (or a group of entities) and/or network function (or a group of functions) is/(are) involved in one (or more) of the representation-model management procedures, in relation to at least one network entity or network function or AI Application.
Examples of the representation-model management procedures, include one (or more, or a combination of) the following procedures:
Network-Domain Monitoring, Representation-Model Handling, Representation-Model Registration, Representation-Model Selection, Representation-Model Aggregation, Representation-Model Configuration, Representation-Model Training, Representation-Model Updating, Representation-Model Monitoring, Representation-Model Detection, Representation-Model Reporting, Representation-Model Subscription, and/or any other procedures related to representation-model management.
In one example, the RMC performs concatenation of multiple representation-models from different network-domains. This will result in one representation-model that represent all concatenated network-domains.
In another example, the RMC monitors changes in the network in relation to at least one network-domain. For example, changes related to existing network-domain and/or a newly added network-domain.
In another example, Upon detection of any network-domain changes, the RMC retrieves information related to those network-domains involved in the reported change(s).
In another example, Upon detection a new network-domain, the RMC creates a representation-model for the detected network-domain.
The new network entity (or entities) and/or network function (or functions) is/(are) involved in one (or more) of the representation-model management action(s), in relation to at least one network entity or network function or AI Application.
Examples of the representation-model management actions, include one (or more, or a combination of) the following actions:
Network-Domain Monitoring

Request/Response/Acknowledge/Notification/Report/Failure;
Representation-Model Handling

Request/Response/Acknowledge/Notification/Report/Failure;
Representation-Model Registration

Request/Response/Acknowledge/Notification/Report/Failure;
Representation-Model Selection

Request/Response/Acknowledge/Notification/Report/Failure;
Representation-Model Aggregation

Request/Response/Acknowledge/Notification/Report/Failure;
Representation-Model Configuration

Request/Response/Acknowledge/Notification/Report/Failure;
Representation-Model Training

Request/Response/Acknowledge/Notification/Report/Failure;
Representation-Model Updating

Request/Response/Acknowledge/Notification/Report/Failure;
Representation-Model Monitoring

Request/Response/Acknowledge/Notification/Report/Failure;
Representation-Model Detection

Request/Response/Acknowledge/Notification/Report/Failure;
Representation-Model Reporting

Request/Response/Acknowledge/Notification/Report/Failure;
Representation-Model Subscription

Request/Response/Acknowledge/Notification/Report/Failure;
Other actions related to Representation-model management procedures.

Representation-Model Profile: is defined as the set of parameters, Key Performance Indicators (KPIs), etc., that a network entity (or set of entities) and/or network function (or a set of functions) may assign (or configure or allocate or recommend, etc.) to be used during at least one of the representation-model management procedure(s). Table 1, shows example of Representation-Model Profile that may be exchanged during any of the representation-model procedures and/or actions in the network.

TABLE 1
Representation-Model Profile parameters that may be exchanged during
any of the representation-model management procedures and/or actions.

| Parameter Name | Semantics description/Examples |
|---|---|
| representation-model procedure ID | |
| representation-model ID | e.g. local ID or global ID, temporary ID, other |
| representation-model version number | e.g. v1.5 |
| representation-model domain | e.g. RU or CU or AI Application, other |
| representation-model domain data | e.g. hardware details, software details, geo-location, |
| | climate, weather, faults alarms, warnings, installation |
| | details, historical maintenance (active, or pro-active), |
| | etc. |
| representation-model detection criteria | e.g. newly added |
| representation-model similarity criteria | e.g. Information-theoretic, Large Margin Nearest |
| | Neighbour, Euclidian distance, Cosine |
| Similarity Measurement Matrix | Similarity matrix between each element in the network- |
| | domain |
| representation-model architecture | e.g. 3 dense layer of ANN |
| Representation-model Weights | e.g. e.g. w1 = 0.2, . . . w100 = 0 |
| Representation-model Size | e.g. 10 Mb |
| Representation-model Format | e.g. JSON, XML, h5 |
| Representation-model Type | e.g. auto-encoder, predictor, embedding |
| Representation-model Validation/Evaluation | e.g. 97% |
| Representation-model Validation/Evaluation Metric | e.g. Accuracy/Reward/Precision/Recall/F1 |
| Representation-model Validation/Evaluation Type | e.g. System Performance/Inference |
| Representation-model Deployment Side | |
| Representation-model Training Side | |
| Representation-model Inference Side | |
| Training Session/procedure ID(s) | |
| Selection Session/procedure ID(s) | |
| Registration Session/procedure ID(s) | |
| Configuration Session/procedure ID(s) | |
| Subscription Session/procedure ID(s) | |
| Update Session/procedure ID(s) | |
| Detection Session/procedure ID(s) | |
| Other LCM Session/procedure ID(s) | |
| Updated Time | e.g. date |
| Updated Location | e.g. Cell ID, location coordinates, . . . |
| Subscriber List | e.g. Cell ID, Entity ID, IP(s) . . . ) |
| other | |

In certain examples, one or more of the following may be assumed:
Various techniques (e.g. solutions, embodiments, examples, FIGURES, other description) described in relation to new network entity (or entities) and/or function (or functions) can also be used with/applied to existing network entities (e.g. gNB, eNB, NG-RAN, MME, UPF, SMF, AMF, other) and signalling and/or messages (e.g. RRC, NAS), and/or IEs, and/or interfaces X2, Xn, S1, NG, F1, E1.
Various techniques may be extended to a mix of new and/or existing network entities (and/or functions) and/or interfaces and/or signalling and/or messages, and/or IEs.
The terms functionality/use-case/configuration/scenario/site may be used interchangeably in the present disclosure.
The terms model and model functionality may be used interchangeably in the present disclosure.
Various techniques may also be applied to non-3GPP entities.
Various techniques may be applied to various types of communication systems, such as 4G, 4G-Advanced, 5G, 5G-Advanced, and 6G. Moreover, various techniques may be applied (in full or part or modified) to systems of Non-Terrestrial Networks (NR-NTN and/or IoT-NTN), in addition to Terrestrial Networks (TN).

### 1. Examples of Representation-Model Procedures

FIG. 2 shows an example of representation-model management procedure with two actions A and B, between two network (NW) entities X,Y (or NW Functions X, Y, or NW Entity X and NW Function Y), that can be any of the above mentioned examples of procedures and actions.

FIG. 3 shows an example of representation-model registration procedure with two request and response actions, between a Client and RMC. The term “Client” may be used to refer to any network entity (or function), UE (or a group of UEs), server, AI Application(s), or Application Function (AF).

### 2. Examples of Representation-Model Management Stages

In the following representation-model management stages are described, explained, as an example, in relation to interaction between a NW entity and RMC. The skilled person will appreciate that these examples can be modified, for example to interaction between two NW entities (or functions):

### 2.1 Network-Domain Monitoring

The following is the RMC behaviour during the network-domain detection stage:
Step 1: The RMC monitors changes in the network in relation to at least one network domain. For example, changes related to existing network-domain and/or a newly added network-domain.
Step 2: Upon detection of any network-domain changes, the RMC retrieves information related to those network-domains involved in the reported change(s).
In one example, the RMC may detect the change by requesting status of network-domain directly from one (or more) network entity (and/or function) or via at least one other network entity (or function). In turn, the entity(-ies) or function(s) may respond with current status of the desired network-domain.
In another example, the change in a network-domain may be reported (or indicated) to the RMC (or at least one other network entity (and/or function)) periodically or based on a pre-configured event rule, policy, condition, and/or threshold (e.g. configured by the network).
In another example, a client may subscribe to RMC to obtain any reporting of any changes or updates in representation-model(s) and/or network-domain(s). This request may include information related to given representation-model(s) and/or network-domain(s).
Step 3: the RMC may behave in at least one of the following:
Upon detection a new network-domain, the RMC may trigger Representation-model Registration procedure, Configuration and/or Training, etc.
Upon detection of any change/update of existing network-domain, the RMC may trigger Representation-model Configuration and/or Training, or Representation-Model Profile update, etc.
In another example, the RMC may request any newly added network-domain to register its information with another network entity (entities) and/or function (or functions).

### 2.2 Representation-Model Registration

In this stage the client register(s) in the RMC database to provide the related information:
Step1: The client triggers the Representation-model Registration procedure for a representation-model for given/specific network-domain(s) by sending a representation-model registration request message, including any available assistance information related to the representation-model.
For example: representation-model session ID, representation-model ID, representation-model type (e.g. auto-encoder, predictor, other), network-domain, network-domain historical data, version number, representation-model deployment side, representation-model training side, representation-model inference side, representation-model training online or offline, representation-model training type, representation-model size, representation-model format, number of parameters, representation-model input/output, similarity metrics, KPIs, number of layers, other
For example: hardware details, software details, Geo-location, climate, weather, faults alarms, warnings, installation details, historical maintenance (active, or proactive) related to the NW Entities or NW Functions (e.g. AI Applications) and any other fusion data from sensors and/or documents related to the NW Entities or NW Functions (e.g. AI Applications).
Step2a: the RMC may register the representation-model and assign a representation-model session ID (if not previously assigned) and stores this representation-model and optionally, other parameters as those described in the present disclosure, in the RMC (e.g. database).
Step2b: the RMC may store information on the representation-model architecture, weights and metadata (and other model related information) and/or other information related to the model (e.g. received in the client representation-model registration request) into a representation-model template (e.g., namely, Representation-Model Profile). Also, additionally, the RMC may store the representation-model and/or representation-model information with time and location information (e.g. time and/or location of representation-model registration request, validity of time and/or location of stored or registered representation-model and/or representation-model information).
Step3b: the RMC responds that the representation-model event is registered successfully with an assigned session ID. Additional, optionally, sends session ID, other information related to the representation-model event.

### 2.3 Representation-Model Selection

Step1: The client triggers a representation-model selection process by sending a representation-model selection request to RMC. This request may include information related to representation-model/network-domain/use-case/scenario/configuration. For example:
Representation-model selection conditions/criteria on any parameter in Representation-Model Profile.
In an example, the representation-model selection request may include pre-defined Aggregate Function(s). The aggregate function performs a calculation on a set of Representation-Model Profile(s) that fulfil the selection information in the representation-model selection request. For example:
Concatenation Function: performs concatenation of all representation-models that fulfil the selection. This will result in one representation-model that represent all concatenated representation-models.
Best Evaluation Function: return the representation-model that has the best evaluation value.
Other actions related to representation-models aggregation process.
Step 2: The RMC sends to the client, if available, the selected Representation Model Profile(s) that fulfil the selection information in the model selection request.
For example, the RMC may also send the following information (e.g. in new or existing IE):
The Representation-Model Profile(s) (and/or any other information related to selected representation-model) that has the best evaluation value (i.e. based on Evaluation Criteria).
In an example, the RMC may concatenate two or more representation-models that fulfil the model selection conditions/criteria and send to the concatenated representation-model to the client.

### 2.4 Representation-Model Configuration

Step 1: the client (or a UE, NW entity or function) triggers the representation-model configuration procedure for a representation-model for given/specific network-domain(s) by sending a model configuration request message (e.g. representation-model configuration request message), including information related to representation-model configuration.
For example: representation-model type (e.g. neural network auto-encoder, neural network predictor), representation-model size (e.g. number of layers/number of parameter), representation-model inputs (e.g. input dimension), representation-model output (e.g. output dimension), other.
Step 2: the RMC configures the representation-model based on parameters (and/or assistance information) in the request message.
Step 3: the RMC may reply to client, for example, by sending a message to acknowledge that it has successfully configured the representation-model (e.g. representation-model configuration request acknowledge/response message), the RMC may (optionally) performs the following:
the RMC send to the client the configured representation-model (and/or configuration parameters, and/or other related information), and/or
the RMC stores the new configured representation-model (and/or configuration parameters, and/or other related information), for example in RMC database.

In another example, if the RMC fails to configure the representation-model, it reject the Client request, and indicate in the failure message (e.g. representation-model configuration request reject/failure message, or any other suitable message naming).

In a related example, the RMC may include a cause value for the failure to configure the model, e.g. InsufficientParamtersToConfigureModel, or Configuration of Representation-Model is not supported, or any other suitable cause value naming).

### 2.5 Representation-Model Training

Step 1: the client (or UE or a NW entity or function) triggers the representation-model training procedure for a representation-model by sending a model training request message (e.g. representation-model training request message), including information related to representation-model training.
For example: representation-model Profile(s), representation-model(s), training dataset, validation dataset, training optimization, other.
Step 2: the RMC trains the representation-model based on training parameters in the request message.
Step 3: the RMC may reply to client, for example, by sending a message to acknowledge that it has successfully trained the representation-model (e.g. representation-model training request acknowledge/response message), the RMC may (optionally) performs the following:
the RMC sends to the client the trained representation-model, or/and
the RMC stores the new trained representation-model and/or any information related to the training process (e.g. training accuracy, training parameters, training offline/online, other information). For example, in RMC database.

In another example, if the RMC fails to train the representation-model, it reject the Client request, and indicates in the failure message (e.g. representation-model training request reject/failure message, or any other suitable message naming).

In a related example, the RMC may include a cause value for the failure to configure the model, e.g. Representation-ModelTrainingNotSupported, or any other suitable cause value naming).

### 3. Example on Representation-Model Management

### 3.1 Advance Hardware Fault Management System (Fault Prediction)

The goal/functionality of this example is to predict the Hardware Fault for a newly added network element to the mobile network using a representation-model for the network-domain. In this example, the scenario has the following definitions and setup:
The client is the Fault Management.
The network-domain can be defined as the RUs in the mobile network.
The network-domain data can be defined as the RU features, which used as input for the representation-model. For example, D_{RU}={f₁: RU manufacture, f₂: RU alarm 1 (Power Supply Unit Failure), f₃: RU alarm 2 (Temperature), f₄: Number of Antennas connected to the RU, f₅: DU manufacture connecting to RU, f₆: Number of RUs connected to the DU}, which has a size of six.
The representation-model is an Auto-Encoder (e.g., AE Ru) deep neural network that produce code at the encoder output part, this code is the representation-vector.
Let's assume there are existed two RUs in the network-domain, RUₐ and RU_{b}, where the data of each feature is:
D_{RU}_{ₐ}={RUₐ manufacture=A, RUₐ alarm 1 (Power Supply Unit Failure)=Overload, RU alarm 2 (Temperature)=High, Number of Antennas connected to the RUₐ=3, DUₓ manufacture connecting to RUₐ=A, Number of RUs connected to the DUₓ=3}
D_{RU}_{_{b}}={RU_{b} manufacture=B, RU_{b} alarm 1 (Power Supply Unit Failure)=Input Voltage fluctuations, RU_{b} alarm 2 (Temperature)=High, Number of Antennas connected to the RU_{b}=6, DU_{c} manufacture connecting to RU_{b}=C, Number of RUs connected to the DU_{c}=6}
Recently, the human operator adds the new network element RU_{z} with data:
D_{RU}_{_{z}}={RU_{z} manufacture=C, RU_{z} alarm 1 (Power Supply Unit Failure)=none, RU_{z} alarm 2 (Temperature)=normal, Number of Antennas connected to the RU_{z}=3, DU_{c} manufacture connecting to RU_{z}=C, Number of RUs connected to the DU_{c}=3}

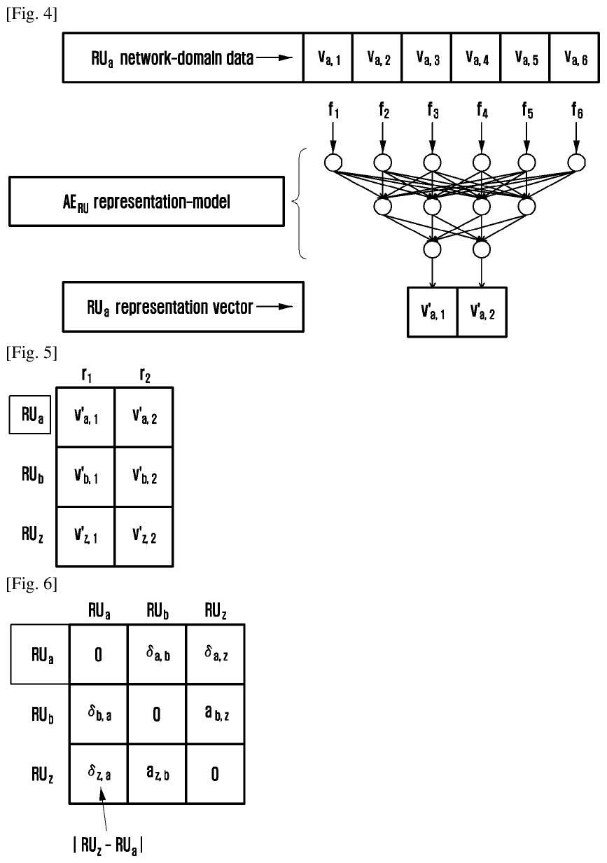

The following is the RMC behaviour:
Step 1: After the installation and commissioning of new network-element RU_{z}. The fault management triggers a representation-model selection process for receiving the latest version of the RU representation-model, by sending a representation-model selection request to the RMC.
Step 2: The RMC sends back the representation-model AE_{RU} to the fault management.
Step 3: the fault management produce the similarity matrix following the below procedure:
The representation-model AF RU use the RUs data: D_{RU}_{ₐ},D_{RU}_{_{b}}, D_{RU}_{_{z}} to produce the representation vectors at the encoder output. See FIG. 4.
Then, construct a matrix with three rows (number of network element) and two columns (size of AE_{RU} encoder output) and has 3*2=6 entries of numerical values. See FIG. 5.
Next, the fault management produces the Similarity matrix. For example the Euclidian distance between the rows can be used to calculate δ_{z,a}=|RU_{z}-RUₐ|, where the most similar Network entities should have 8 value near 0 (e.g., for at the same RU: δ_{z,z}=|RU_{z}-RU_{z}|=0). See FIG. 6.
Lastly, If fault management sense Alarm/Fault at RUₐ and δ_{z,a}=|RU_{z}-RUₐ|≈O, then the RUₐ & RU_{z} are very similar or close and the Fault management system predicts that the RU_{z} will develop similar Alarm/Fault to RUₐ. For example, alarm 2 (Temperature)=High.

### 3.2 Advance SONs Fault Management System (Fault(s) Prediction)

The goal/functionality of this example is to predict the functionality Fault for a newly added network element to the mobile network using a representation-model for the network-domain. In this example, the scenario has the following definitions and setup:
The client is the Fault Management.
The network-domain can be defined as the SONs (Self Organizing Networks) in the mobile network.
The network-domain data can be defined as the SON features, which used as input for the representation-model. For example, D_{SON}={f₁: Antenna Tilt, f₂: Antenna Azimuth, f₃: Cell switch (On/Off), f₄: Downlink Tx power, f₅: SON developer, f₆: SON active bugs/alarms list from 1:5}, which has a size of six.
The representation-model is an Auto-Encoder (e.g., AE son) deep neural network that produce code at the encoder output part, this code is the representation-vector.
In certain examples, it may be assumed there are two SON functions in the network-domain, SON for CCO (Capacity and Coverage Optimization) and SON_{b} for COC (Cell Outage Compensation), where the data of each feature is:
D_{SON}_{ₐ}={Antenna Tilt=_{α}^{O}, Antenna Azimuth=_{β}^{O}, Cell switch=On, Downlink Tx power=_{ρ} dBm, SON developer=A, SON active bugs/alarms list={1,3,5}},
D_{SON}_{_{b}}={Antenna Tilt=_{γ}^{O}, Antenna Azimuth=_{ω}^{O}, Cell switch=Off, Downlink Tx power=_{η} dBm, f₅: SON developer=B, f₆: SON active bugs/alarms list={2,4}},
Recently, the human operator adds the new network element SON for ES (Energy Saving) with data:
D_{SON}_{_{z}}={Antenna Tilt=_{φ}^{O}, Antenna Azimuth=_{ψ}^{O}, Cell switch-Off, Downlink Tx power=_{ζ} dBm, f₅: SON developer=A, f₆: SON active bugs/alarms list={2,3,5}},

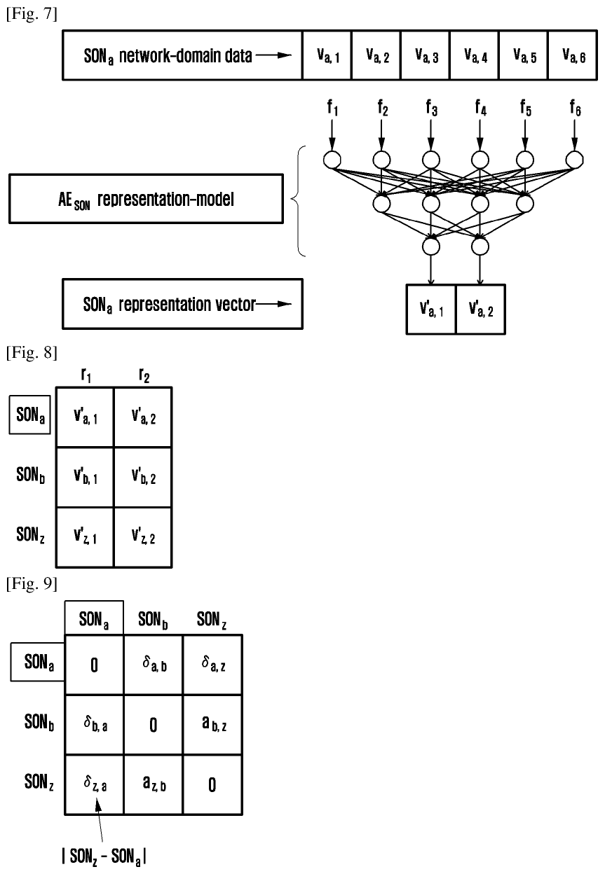

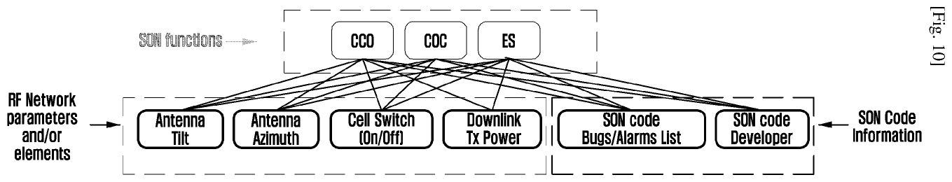

The following is the RMC behaviour:
Step 1: After the installation and configuration of the new network-element SON_{z}. The fault management triggers a representation-model selection process for receiving the latest version of the RU representation-model, by sending a representation-model selection request to the RMC.
Step 2: The RMC sends back the representation-model AE son to the fault management.
Step 3: the fault management produce the similarity matrix following the below procedure:
The representation-model AE_{SON} use the RUs data: D_{SON}_{ₐ}, D_{SON}_{_{b}}, D_{SON}_{_{z}} to produce the representation vectors at the encoder output. See FIG. 7.
Then, construct a matrix with three rows (number of network element) and two columns (size of AE_{RU} encoder output) and has 3*2=6 entries of numerical values. See FIG. 8.
Next, the fault management produces the Similarity matrix. For example the Euclidian distance between the rows can be used to calculate δ_{z,a}=|SON_{z}-SONₐ|, where the most similar Network entities should have 8 value near 0 (e.g., for at the same SON: δ_{z,z}=|SON_{z}-SON_{z}|=0). See FIG. 9.
Lastly, If fault management sense Alarm/Fault at SON and δ_{z,a}=|SON_{z}-SONₐ|≈O, then the SON_{z}& SONₐ are very similar or close and the Fault management system predicts that the SON_{z} will develop similar Alarm/Fault to SON_{z} for example, bugs/alarms: {1} in addition to the existing ones: {2,3,5}.

### 3.3 Advance SONs Conflict Prediction

The goal/functionality of this example is to predict the conflicts between SONs functions (or between AI Applications), using a representation-model. In this example, the scenario has the following definitions and setup:
The client is the SON Coordination.
The network-domain can be defined as the SONs in the mobile network.
The network-domain data can be defined as the SON features, which used as input for the representation-model. For example, D_{SON}={f₁: Antenna Tilt, f₂: Antenna Azimuth, f₃: Cell switch (On/Off), f₄: Downlink Tx power, f₅: SON developer, f₆: SON active bugs/alarms list from 1:5}, which has a size of six.
The representation-model is an Auto-Encoder (e.g., AE son) deep neural network that produce code at the encoder output part, this code is the representation-vector.
Let's assume there are existed two SON functions in the network-domain, SONₐ for CCO (Capacity and Coverage Optimization) and SON_{b} for COC (Cell Outage Compensation), where the data of each feature is:
D_{SON}_{ₐ}={Antenna Tilt=_{α}^{O}, Antenna Azimuth=_{β}^{O}, Cell switch=On, Downlink Tx power=_{ρ} dBm, SON developer=A, SON active bugs/alarms list={1,3,5}},
D_{SON}_{_{b}}={Antenna Tilt=_{γ}^{O}, Antenna Azimuth=_{ω}^{O}, Cell switch=On, Downlink Tx power=n dBm, f₅: SON developer=B, f₆: SON active bugs/alarms list={2,4}},
In addition the assumption includes, that both existing SONs have already reached the agreement regarding configuring the comment RF parameters. For example: _{α}^{O}≈_{γ}^{O}, _{β}^{O}≈_{ω}^{O}, Cell switch=On and ρ=η. See FIG. 10.
Recently, the human operator adds the new network element SON_{z} for ES (Energy Saving) with data:
D_{SON}_{_{z}}={Antenna Tilt=_{φ}^{O}, Antenna Azimuth=_{ω}^{O}, Cell switch=On, Downlink Tx power=ζ dBm, f₅: SON developer=A, f₆: SON active bugs/alarms list={2,3,5}}.

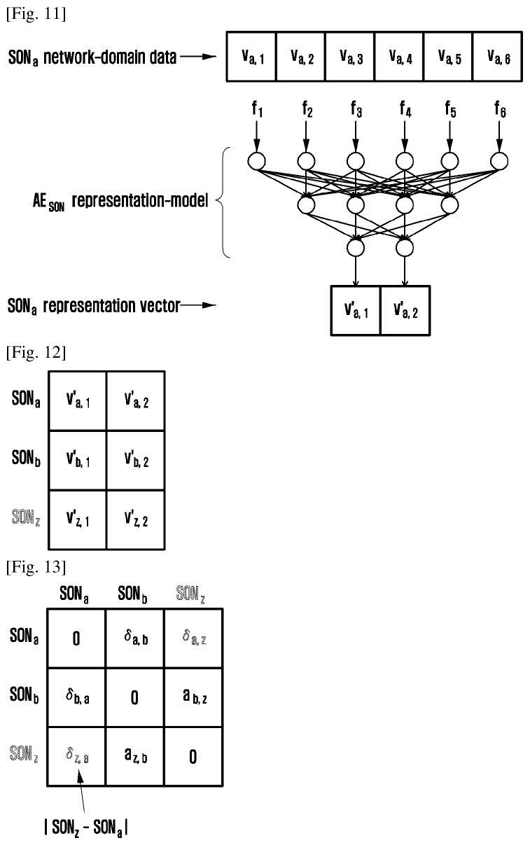

The following is the RMC behaviour:
Step 1: After the installation and configuration of the new network-element SON_{z}. The SON coordination triggers a representation-model selection process for receiving the latest version of the SON representation-model, by sending a representation-model selection request to the RMC.
Step 2: The RMC sends back the representation-model AE_{SON} to the SON coordination.
Step 3: the SON coordination produce the similarity matrix following the below procedure:
The representation-model AE_{SON} use the SONs data: D_{SON}_{ₐ}, D_{SON}_{_{b}}, D_{SON}_{_{z}} to produce the representation vectors at the encoder output. See FIG. 11.
Then, construct a matrix with three rows (number of network element) and two columns (size of AE Ry encoder output) and has 3*2=6 entries. See FIG. 12.
Next, the SON coordination produces the Similarity matrix. For example the Euclidian distance between the rows can be used to calculate δ_{z,a}=|SON_{z}-SONₐ|, where the most similar Network entities should have 8 value near 0 (e.g., for at the same SON: δ_{z,z}=|SON_{z}-SON_{z}|=0). See FIG. 13.
Lastly, If SON coordination sense between SON_{z} and SON_{z} that δ_{z,a}=|SON_{z}-SONₐ|≈O, then the SON_{z} & SONₐ are very similar or close and the SON_{z} may develop conflict(s) with SONₐ. For example, by predicting the following parameters conditions for SONₐ and SON_{z}, the SON coordination by using AE_{SON} representation-model can predicts that there is conflict(s) related to configuring the Antenna Tilt and Downlink Tx Power between SONₐ and SON_{z}.

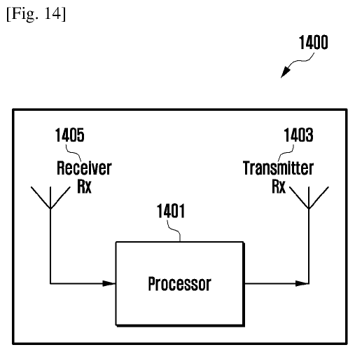

FIG. 14 is a block diagram of an exemplary network entity that may be used in examples of the present disclosure. The skilled person will appreciate that a network entity may be implemented, for example, as a network element on a dedicated hardware, as a software instance running on a dedicated hardware, and/or as a virtualised function instantiated on an appropriate platform, e.g. on a cloud infrastructure.

The entity 1400 comprises a processor (or controller) 1401, a transmitter 1403 and a receiver 1405. The receiver 1405 is configured for receiving one or more messages from one or more other network entities, for example as described above. The transmitter 1403 is configured for transmitting one or more messages to one or more other network entities, for example as described above. The processor 1401 is configured for performing one or more operations, for example according to the operations as described above.

The techniques described herein may be implemented using any suitably configured apparatus and/or system. Such an apparatus and/or system may be configured to perform a method according to any aspect, embodiment, example or claim disclosed herein. Such an apparatus may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). The one or more elements may be implemented in the form of hardware, software, or any combination of hardware and software.

It will be appreciated that examples of the present disclosure may be implemented in the form of hardware, software or any combination of hardware and software. Any such software may be stored in the form of volatile or non-volatile storage, for example a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like.

It will be appreciated that the storage devices and storage media are embodiments of machine-readable storage that are suitable for storing a program or programs comprising instructions that, when executed, implement certain examples of the present disclosure. Accordingly, certain examples provide a program comprising code for implementing a method, apparatus or system according to any example, embodiment, aspect and/or claim disclosed herein, and/or a machine-readable storage storing such a program. Still further, such programs may be conveyed electronically via any medium, for example a communication signal carried over a wired or wireless connection.

While the invention has been shown and described with reference to certain examples, it will be understood by those skilled in the art that various changes in form and detail may be made therein without departing from the scope of the invention, as defined by the appended claims.

### ABBREVIATIONS/DEFINITIONS

In the present disclosure, the following acronyms/definitions are used.
3G 3^{rd} Generation
3GPP 3^{rd} Generation Partnership Project
4G 4th Generation
5G 5th Generation
6G 6th Generation
AF Application Function
AI Artificial Intelligence
AMF Access and Mobility Management Function
ANN Artificial Neural Network
CCO Capacity and Coverage Optimisation
CN Core Network
COC Cell Outage Compensation
CP Control Plane
CU Centralised Unit
DU Distributed Unit
E1 Point-to-point interface between gNB-CU-CP and gNB-CU-UP
eNB Base Station
ES Energy Saving
F1 Interface between gNB-CU and gNB-DU
FM Fault Management
gNB 5G Base Station
H5 Hierarchical Data Format 5
ID Identity
IE Information Element
IoT Internet of Things
IP Internet Protocol
IRP Integration Reference Point
IS Information Service
JSON JavaScript Open Notation
KPI Key Performance Indicator
LCM Life Cycle Management
ML Machine Learning
MME Mobility Management Entity
NAS Non Access Stratum
NF Network Function
NFV Network Function Virtualisation
NG Next Generation
NG Interface between 5G RAN and 5G CN
NR New Radio
NTN Non-Terrestrial Network
NW Network
OAM Operations and Maintenance
O-RAN Open RAN
PCI Physical Cell ID
RAN Radio Access Network
RF Radio-Frequency
RMC Representation-Model Management Controller
RRC Radio Resource Control
RU Radio Unit
S1 Interface between RAN and CN
SMF Session Management Function
SON Self-Organizing Network
TN Terrestrial Network
TS Technical Specification
Tx Transmit
UE User Equipment
UP User Plane
UPF User Plane Function
VNF Virtual Network Function
X2/Xn Interface between RAN nodes
XML extensible Markup Language

1. A method performed by a first network entity in a wireless communications network, the method comprising:
transmitting, to a second network entity/function, a first message relating to a representation-model management procedure; and
as a response to the first message, receiving, from a second network entity, a second message relating to the representation-model management procedure.

2. The method of claim 1,
wherein the first message and/or the second message comprises information relating to one or more representation-models relating to the procedure,
wherein the information comprises a representation-model profile,
wherein the representation-model profile comprises one or more parameters and/or Key Performance Indicators (KPIs) that one or more network entities/functions may assign, configure, allocate and/or recommend to be used during the representation-model management procedure, and
wherein the first message comprises a representation-model registration request message and the second message comprises a representation-model registration response message.

3. The method of claim 2, wherein the information comprises at least one parameter including at least one of a representation-model procedure ID, a representation-model ID, a representation-model version number, a representation-model domain, a representation-model domain data, a representation-model detection criteria, a representation-model similarity criteria, a Similarity Measurement Matrix, a representation-model architecture, a Representation-model Weights, a Representation-model Size, a Representation-model Format, a Representation-model Type, a Representation-model Validation/Evaluation, a Representation-model Validation/Evaluation Metric, Representation-model Validation/Evaluation Type, a Representation-model Deployment Side, a Representation-model Training Side, a Representation-model Inference Side, Training Session/procedure ID(s), Selection Session/procedure ID(s), Registration Session/procedure ID(s), Configuration Session/procedure ID(s), Subscription Session/procedure ID(s), Update Session/procedure ID(s), Detection Session/procedure ID(s), Other LCM Session/procedure ID(s), an Updated Time, an Updated Location, or a Subscriber List.

4. The method of claim 1,
wherein the first network entity and the second network entity is associated with Network-Domain Monitoring comprising monitoring or detecting changes in the network in relation to at least one network-domains,
wherein the at least one network-domains includes changes related to at least one existing network-domains, or at least one newly added network-domains.

5. The method of claim 4, wherein monitoring and/or detecting changes comprises:
requesting, a status of at least one network-domains from at least one network entities;
receiving, from the network entities, a current status of the one or more network-domains; and
subscribing to obtain any reporting of any changes or updates in one or more representation-models and/or one or more network-domains.

6. The method of claim 4, further comprising:
performing upon detection of a new network-domain, triggering a representation-model registration procedure, configuration and/or training;
performing upon detection of a change/update of an existing network-domain, triggering representation-model configuration, training and/or representation-model profile update;
performing upon detection of one or more newly added network-domains, requesting the newly added network-domains to register related information with one or more network entities/functions;
concatenating two or more representation-models from different network-domains to obtain a representation-model representing the concatenated/combined network-domains; and
combining two or more representation-models from different network-domains to obtain a representation-model representing the concatenated/combined network-domains.

7. The method of claim 1, further comprising: in response to detecting a change in one or more network-domains, retrieving information related to one or more network-domains that are involved in the change; and
in response to detecting a change in one or more network-domains (e.g. addition, removal, modification and/or reconfiguration of one or more network-domains), creating, by the first or second entity/function (e.g. RMC) a representation-model related to one or more network-domains that are involved in the change;
wherein the representation-model comprises a mapping of network-domain data to a set of one or more numerical values (e.g. a vector), wherein the network-domain comprises one or more of: a network entity/function; UE; server; AI application; and/or application function, and
wherein the network-domain data comprises information relating to one or more of: one or more network-domains, a relation between two or more network-domains, and historical data.

8. A first network entity in a wireless communications network, the network entity comprising:
a transceiver; and
a controller coupled with the transceiver, the controller configured to:
transmit, to a second network entity/function, a first message relating to a representation-model management procedure; and
as a response to the first message, receive, from a second network entity, a second message relating to the representation-model management procedure.

9. The first network entity of claim 8,
wherein the first message and/or the second message comprises information relating to one or more representation-models relating to the procedure,
wherein the information comprises a representation-model profile,
wherein the representation-model profile comprises one or more parameters and/or Key Performance Indicators (KPIs) that one or more network entities/functions may assign, configure, allocate and/or recommend to be used during the representation-model management procedure, and
wherein the first message comprises a representation-model registration request message and the second message comprises a representation-model registration response message.

10. The first network entity according to claim 9, wherein the information comprises at least one parameter including at least one of a representation-model procedure ID, a representation-model ID, a representation-model version number, a representation-model domain, a representation-model domain data, a representation-model detection criteria, a representation-model similarity criteria, a Similarity Measurement Matrix, a representation-model architecture, a Representation-model Weights, a Representation-model Size, a Representation-model Format, a Representation-model Type, a Representation-model Validation/Evaluation, a Representation-model Validation/Evaluation Metric, Representation-model Validation/Evaluation Type, a Representation-model Deployment Side, a Representation-model Training Side, a Representation-model Inference Side, Training Session/procedure ID(s), Selection Session/procedure ID(s), Registration Session/procedure ID(s), Configuration Session/procedure ID(s), Subscription Session/procedure ID(s), Update Session/procedure ID(s), Detection Session/procedure ID(s), Other LCM Session/procedure ID(s), an Updated Time, an Updated Location, or a Subscriber List.

11. The first network entity of claim 8,
wherein the first network entity and the second network entity is associated with Network-Domain Monitoring comprising monitoring or detecting changes in the network in relation to at least one network-domains,
wherein the at least one network-domains includes changes related to at least one existing network-domains, or at least one newly added network-domains.

12. The first network entity of claim 11, wherein the controller is further configured to:
request, a status of at least one network-domains from at least one network entities;
receive, from the network entities, a current status of the one or more network-domains; and
subscribe to obtain any reporting of any changes or updates in one or more representation-models and/or one or more network-domains.

13. The first network entity of claim 11, wherein the controller is further configured to:
perform upon detection of a new network-domain, triggering a representation-model registration procedure, configuration and/or training;
perform upon detection of a change/update of an existing network-domain, triggering representation-model configuration, training and/or representation-model profile update; and
perform upon detection of one or more newly added network-domains, requesting the newly added network-domains to register related information with one or more network entities/functions.

14. The first network entity of claim 11, wherein the controller is further configured to:
concatenate two or more representation-models from different network-domains to obtain a representation-model representing the concatenated/combined network-domains; and
combine two or more representation-models from different network-domains to obtain a representation-model representing the concatenated/combined network-domains.

15. The first network entity of claim 8, wherein the controller is further configured to:
in response to detecting a change in one or more network-domains, retrieve information related to one or more network-domains that are involved in the change; and
in response to detecting a change in one or more network-domains (e.g. addition, removal, modification and/or reconfiguration of one or more network-domains), create, by the first or second entity/function (e.g. RMC) a representation-model related to one or more network-domains that are involved in the change;
wherein the representation-model comprises a mapping of network-domain data to a set of one or more numerical values (e.g. a vector), wherein the network-domain comprises one or more of: a network entity/function; UE; server; AI application; and/or application function, and
wherein the network-domain data comprises information relating to one or more of: one or more network-domains, a relation between two or more network-domains, and historical data.
